(19) United States
(12) Patent Application Publication
(10) Pub. No.: US 2010/0195461 A1
(43) Pub. Date: Aug. 5, 2010

(54) Multi-Session Pre-Recorded Storage Medium

(75) Inventor: Douglas M. Carson, Cushing, OK (US)

Correspondence Address: FELLERS, SNIDER, BLANKENSHIP, BAILEY & TIPPENS, PC, 100 NORTH BROADWAY, SUITE 1700, OKLAHOMA CITY, OK, 73102-8820, US

(73) Assignee: DOUG CARSON & ASSOCIATES, INC., Cushing, OK (US)

(21) Appl. No.: 12/698,971

(22) Filed: Feb. 2, 2010

Related U.S. Application Data
(60) Provisional application No. 61/149,102, filed on Feb. 2, 2009.

(51) Int. Cl. G11B 20/00

(52) U.S. Cl. 369/47.15; G9B/20

(57) ABSTRACT

Apparatus characterized as a multi-session data storage medium such as an optical disc, and method for formatting the same. In accordance with various embodiments, a first session is recorded onto the medium with a first set of user data. A second session is subsequently recorded onto the medium with a second set of user data. The second session contactingly abuts the first session without the use of an intervening linking area therebetween. This enhances the data storage capacity of the medium irrespective of the total number of sessions applied thereto. In some embodiments, the first session is described by a first file system and the second session is described by a different, second file system independent of the first file system. The respective file systems may be accessed by different readback systems, such a personal computer (PC) and a gaming system.

### RELATED APPLICATION

The present application makes a claim of domestic priority under 35 U.S.C. §119(e) to U.S. Provisional Patent Application No. 61/149,102 filed Feb. 2, 2009, which is hereby incorporated by reference.

### BACKGROUND

Data storage media are used to store and retrieve large amounts of digitally encoded data in a fast and efficient manner. Such media have been commercially provided in a number of different forms, such as magnetic, optical and solid-state (e.g., flash memory, etc.).

Of particular interest are optical discs, which store data in a form that can be optically transduced in a readback system. Due to their portability, high data storage capabilities, and relative resistance to damage during handling, optical discs largely remain the worldwide medium of choice to provide and distribute video, audio, software (business, games, etc.), and other types of content.

Optical discs can be provided in a variety of formats, such as compact disc (CD), digital versatile disc (DVD), Blu-Ray (BD), hybrid, mini-disc, etc. Optical discs can also be pre-recorded or recordable by the end user (once or many times), which further enhances the versatility of the media across a number of different markets.

The relative ease with which the content of a particular optical disc can be replicated, however, also constitutes one of the larger issues facing the industry; namely, the protection of intellectual property rights in the content stored on the disc. Along these lines, a number of efforts have been taken to copy protect discs so that unauthorized copying of the contents is prevented, or at least reduced.

Well-known multi-session recording techniques (see e.g., ISO 9660/13490, etc.) can be used to control the writing of data over multiple sessions. For example, a medium may be initially provided with a first set of user data (a first session), and then later updated with additional user data in one or more later sessions. Multiple sessions of data may be provided to a medium under different file systems; for example, some game discs can have data arranged under a first file system to allow features to be accessed by a personal computer (PC). A second file system stores the actual game programming which is accessible by a specially configured game system, but not accessible by the PC.

While a variety of multi-session techniques have been proposed, it is common to record each session as a new track to the medium, with associated leadout and linking sectors to provide a buffer between adjacent sessions. The linking sectors are non-used areas (such as on the order of 1 mm in width) to ensure proper playback by the associated disc readers that will access the medium.

With the continued worldwide commercial interest in providing content on optical discs and other types of storage media, there remains a continued need for improvements in the manner in which the content is arranged and identified on the medium. It is to these and other improvements that the present invention is generally directed.

### SUMMARY

Various embodiments of the present invention are generally directed to an apparatus characterized as a multi-session data storage medium such as an optical disc, and method for formatting the same.

In accordance with various embodiments, a first session is recorded onto the medium with a first set of user data. A second session is subsequently recorded onto the medium with a second set of user data. The second session contactingly abuts the first session without the use of an intervening linking area therebetween. This enhances the data storage capacity of the medium irrespective of the total number of sessions applied thereto.

In some embodiments, the first session is described by a first file system and the second session is described by a different, second file system independent of the first file system. The respective file systems may be accessed by different readback systems, such a personal computer (PC) and a gaming system.

These and other features and advantages of the various embodiments can be understood by a review of the following detailed description in conjunction with the appended drawings.

### BRIEF DESCRIPTION OF THE DRAWINGS

FIG. 1 is a readback system adapted to read a data storage medium formatted in accordance with various embodiments of the present invention.

FIG. 2 shows the storage medium of FIG. 1 as a pre-recorded optical disc.

FIG. 3 is a recording system useful in recording data to the disc of FIG. 2.

FIG. 4 shows the storage medium of FIG. 1 as a recordable optical disc.

FIG. 5 is another view of the recordable disc of FIG. 4.

FIG. 6 shows a recording system useful in formatting the recordable disc to accept data in the form of multiple recording sessions.

FIG. 7 shows a storage medium format of the related art.

FIG. 8 shows another storage medium format of the related art with multiple recording sessions.

FIG. 9 shows yet another storage medium format of the related art with multiple recording sessions and multiple file systems.

FIG. 10 illustrates a multi-session storage medium formatted in accordance with various embodiments.

FIG. 11 shows another multi-session storage medium formatted in accordance with various embodiments.

FIG. 12 illustrates yet another multi-session storage medium formatted in accordance with various embodiments.

FIG. 13 shows still another multi-session storage medium formatted in accordance with various embodiments.

### DETAILED DESCRIPTION

Various embodiments of the present invention are generally directed to a method and apparatus for formatting a storage medium, such as an optical disc, to provide improved user data capacity. The storage medium is preferably characterized as a pre-recorded multi-session medium to which multiple file systems are stored. No linking sectors or other control fields (run-in, run-out, etc.) are disposed between the adjacent file systems, thereby freeing this area for use to store additional user data associated with either or both file systems, or with a different file system. These and other features and advantages will become apparent in view of the following detailed discussion.

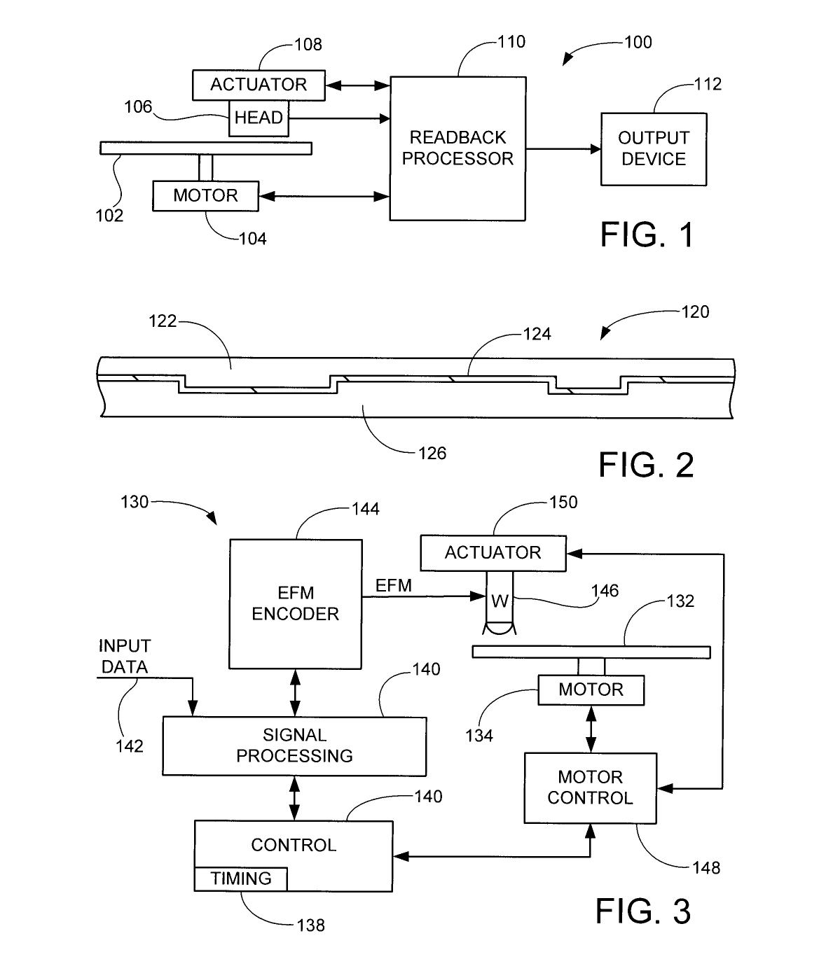

FIG. 1 provides a simplified, functional block diagram of an optical disc readback system 100. An optical disc 102 is rotated by a disc motor 104. An optical disc pick-up assembly comprises a data transducing head assembly 106 supported by a linear actuator assembly 108.

It is common for optical discs such as 102 to have data stored at a constant linear velocity (CLV) so that the disc rotational speed is varied as the head assembly 106 moves across the radius of the disc 102, but such is not limiting.

A readback processor circuit 110 receives a modulated readback signal from the head assembly 106 and performs the appropriate signal processing and conditioning to provide an output signal to an output device 112.

The nature and character of the output device 112 will generally depend upon the type of content stored by the optical disc 102; for example, if the optical disc stores audio data, the output device 112 can comprise an automobile or home stereo system; if the optical disc stores computer data (including MP3 audio files), the output device 112 can comprise a personal computer (PC); if the optical disc stores video data (such as a game or feature length movie), the output device 112 can comprise a television display or home theater system, etc.

FIG. 2 provides a simplified elevational representation of a single layer, pre-recorded optical disc 120 playable by the system 100 of FIG. 1. For ease of discussion, the disc 120 has been arranged in FIG. 2 in a “top-down” read orientation; that is, the read transducer is considered as being located above and is looking down upon the disc, to be consistent with the representation in FIG. 1. The actual relative orientation of the reading layer and read beam can vary as desired.

The disc 120 generally includes a substrate 122 formed of polycarbonate having an outermost diameter of nominally 120 millimeters, mm (10⁻³ meters). An embedded recorded layer 124 comprises a reflective layer of material having a series of pits and lands at different internal elevations. A protective backing layer 126 is preferably formed of resin.

The depth of the pits with respect to the lands is established in relation to the wavelength of the light beam emitted by the head 106 (e.g., nominally one-quarter wavelength). In this way, the pits will have a different reflectivity as compared to that of the lands in the beam as it is reflected back from the disc 120, enabling the generation of a readback signal which is used to decode the data stored on the disc.

The disc 120 is preferably formed by generating a master disc with the desired pit and land sequence, forming a number of stampers from the master disc and then using injection molding or similar techniques to form a population of replica discs from the stampers. Pre-recorded discs such as 120 are typically formed in high volume replication facilities where large quantities of replicas are concurrently formed. Recordable discs can be alternatively formed as described below.

FIG. 3 illustrates a mastering system 130 used to create the master disc from which the disc 120 is replicated. The system 130 is preferably characterized as a laser beam recorder (LBR). A glass master 132 is provided with a spun-coat layer of photoresist, and is rotated by a motor 134.

A control block 136 with associated timing circuitry 138 provides top level control of the mastering process. A signal processing block 140 receives input data from path 142, formats the input data into the desired form and generates the requisite control data, error detection and correction codes, etc. The signal processing block 140 provides this data to an EFM (extended frequency modulation) encoder 144 which generates an EFM signal representative of the desired pit and land sequence on the glass master 132.

The EFM signal is used to modulate a write laser 146 to selectively expose the layer of photoresist. A motor control circuit 148 controls both the rotational speed of the glass master 132 and an actuator 150 used to advance the write laser 146 across the radius of the glass master.

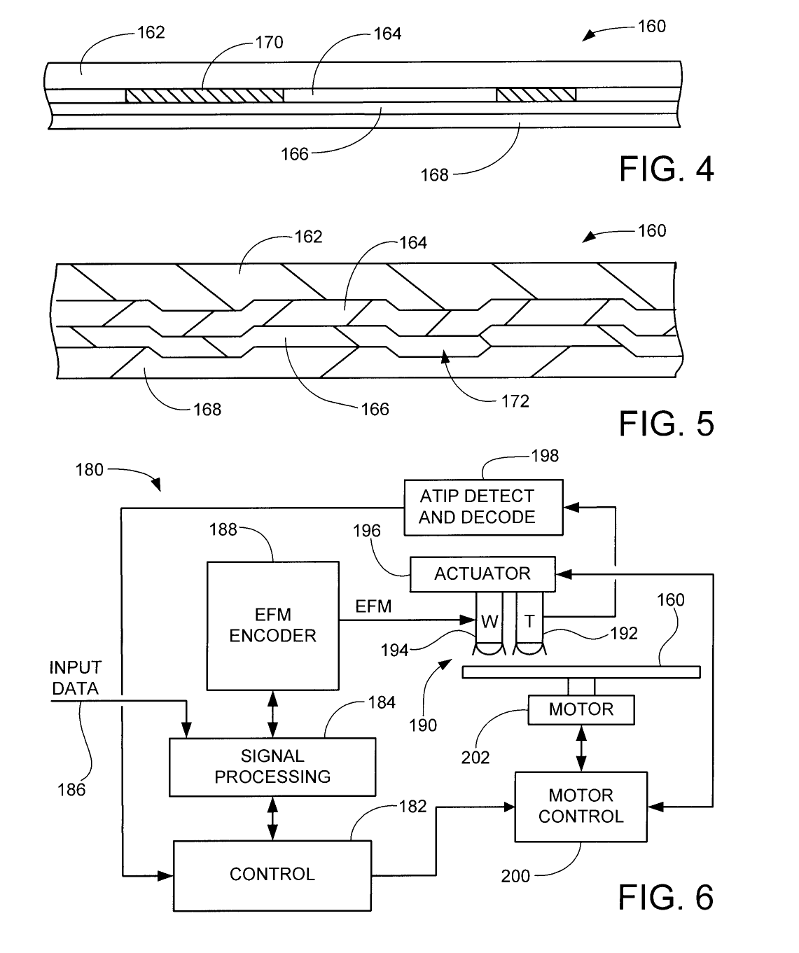

FIG. 4 provides a simplified elevational representation of a portion of a recordable optical disc 160. As with the pre-recorded disc 120 of FIG. 2, the recordable disc 160 is also contemplated as being playable by the readback system 100 of FIG. 1.

The disc 160 generally includes a translucent substrate 162, a recording layer 164 preferably comprising a layer of nominally translucent dye, a reflective layer 166 preferably comprising a gold alloy or similar metal, and a protective backing layer 168.

During a recording operation, a write beam of light selectively impinges the recording layer 164 to cause a localized change in the reflectivity of the layer, such as shown by stripe 170. The stripe 170 has a different reflectivity as compared to the nonexposed portions of the recording layer. Thus, the exposed and non-exposed portions of the recording layer 164, in conjunction with the underlying reflective layer 166, cooperate to function as the pits and lands of the disc 120 of FIG. 2.

At this point it will be noted that recordable media such as 160 are becoming increasingly popular as a means for consumers to create their own media that can be played in standard media players. Commercial application providers are also increasingly using recordable media in lieu of standard replicated media to provide applications to the marketplace. The use of prerecorded media eliminates the time required to utilize a mastering and replication process as depicted by FIG. 3.

For purposes herein, the term “pre-recorded” will be understood to refer to a disc (or other medium) to which data have already been written, either using permanently embossed pits and lands as shown in FIG. 2, or using recordable media as shown in FIG. 4. The term “recordable” will be understood to refer to a disc (or other medium) to which data have yet to be written, and thus not only includes the write-once media of FIG. 4, but read-write media that can be written, erased, and rewritten multiple times.

It follows that a recordable disc such as 160 to which content has been supplied to some, but not all of the available disc recording area can be characterized as having a pre-recorded portion (i.e., that portion to which data have been written) as well as a recordable portion (i.e., that portion to which data have not yet been written).

Those skilled in the art will recognize that the respective views of FIGS. 2 and 4 can be combined to represent different portions of a single hybrid disc having both pre-recorded embossed portions (FIG. 2) as well as one or more recordable portions (FIG. 4).

The sectional view of FIG. 4 shows the disc 160 along a particular track. FIG. 5 is perpendicular to the view of FIG. 4 and provides a sectional view of the disc 160 across several physical tracks. The physical tracks are predefined using a wiggle pre-groove, denoted generally at 172. The pre-groove preferably comprises a continuous spiral that extends from the inner diameter (ID) to the outer diameter (OD) of the disc.

Instead of being perfectly concentric, the pre-groove 172 wobbles at a nominal frequency, such as 22.05 kilohertz (kHz) for a CD-R. This nominal carrier frequency provides motor speed control information to a disc writer system. In addition, the wobble is frequency modulated to provide sector address information commonly referred to as ATIP (absolute time in pre-groove).

The ATIP information is arranged in a number of sequential frames and provides information similar to the information provided by the Q channel in a conventional CD, such as elapsed time (in minutes, seconds and frames), starting and ending times for lead-in and lead-out, and error correction bytes.

ATIP information also typically includes disc type and manufacturer information, a recommended power setting during recording, a maximum recording speed, etc. The physical sectors of data subsequently written to the disc nominally align with the ATIP sectors; that is, the ATIP information serves to define where the actual data sectors will be subsequently placed on the disc.

Wiggle pre-grooves are generally mastered using equipment similar to that shown in FIG. 3. Such pre-grooves are also often used in other types of recordable media, such as recordable DVDs (DVD-R, DVD-R/W), recordable Blu-Ray discs, etc.

FIG. 6 provides a functional block diagram for an optical disc writer system 180 configured to selectively expose the recording layer 164 of a recordable disc 160 to write data thereto.

The system 180 includes a control block 182 that provides top level control for the system. A signal processing block 184 receives input data from path 186, formats the input data into the desired form and generates the requisite control data. The signal processing block 184 provides the processed data to encoder 188 which, as before, generates an EFM signal representative of the desired pit and land sequence on the disc 160.

The system 180 further includes a write assembly 190 comprising a tracking (T) laser assembly 192, a write (W) laser assembly 194 and an actuator 196. The tracking laser assembly 192 emits a light beam with selected focal depth and width to detect the pre-groove 172, while the write laser assembly 194 is modulated by the EFM signal to write the encoded data to the disc. A readback signal from the tracking laser assembly 192 is provided to an ATIP detect and decode block 198.

The block 198 decodes the timing information from the nominal frequency of the wobble to enable a motor control block 200 to provide the necessary control signals to a motor 202 to rotate the disc 160 at the appropriate velocity, and to enable the control block 182 to correctly position the write laser assembly 194 to nominally follow the pre-groove 172.

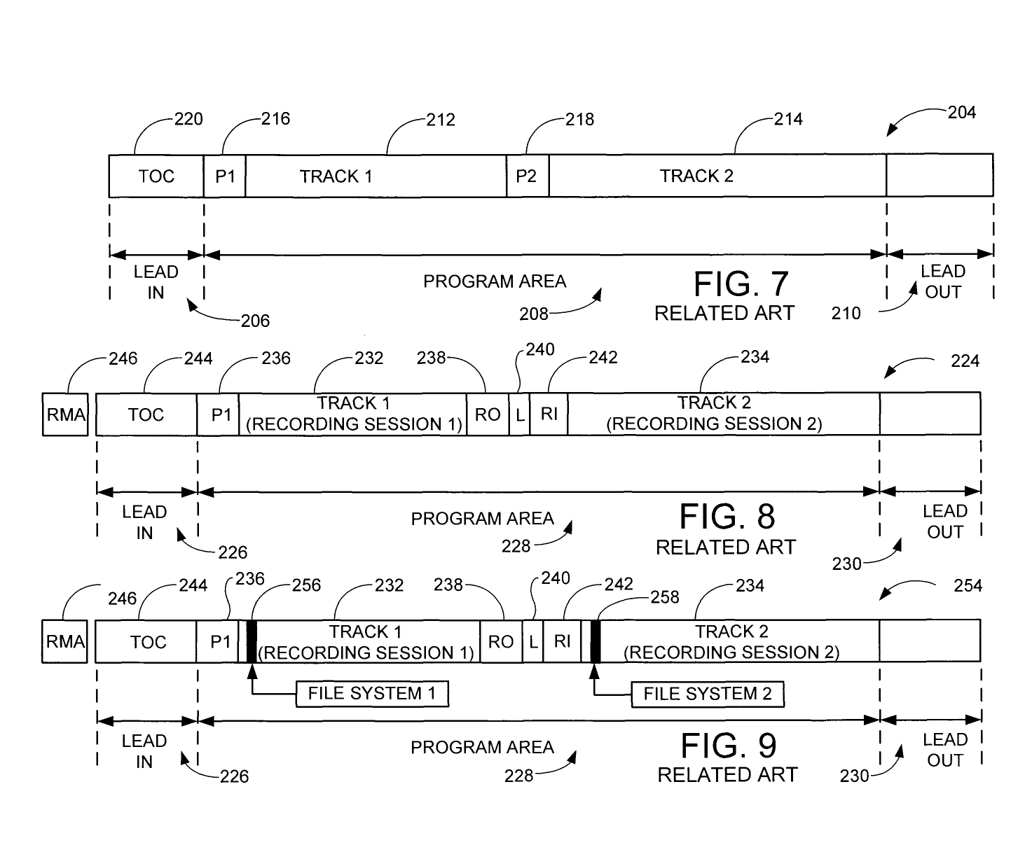

FIG. 7 provides a generalized representation of a format 204 for a selected disc to which data have been written during a single recording session. The format 204 includes a lead-in zone 206, a program area 208 and a lead-out zone 210. The content data stored to the program area 208 are shown to be arranged in two tracks, although this is for illustration only. It will be appreciated that the data shown in FIG. 7 can be arranged across a single recording layer, or across multiple recording layers of a medium.

The tracks are identified at 212 and 214, and are separated by pause fields 216 and 218. For clarity, the term “track” as used in FIG. 7 does not refer to a physical track (e.g., a single revolution of the disc), but rather to a “logical track;” that is, a self-contained zone in which a cohesive set of data are stored (such as an audio track on an audio CD, etc.), as used in the art.

The lead-in and lead-out zones 206, 210 are configured in accordance with the applicable format to provide signals that allow the readback system 100 (FIG. 1) to identify the start and end of the disc. The lead-in zone 206 is shown to include a table of contents (TOC) 220 which identifies, inter alia, the starting and ending addresses for each track, the start address for the lead-out 210, etc.

Because the data in FIG. 7 are arranged as a single session, no arrangements need be made to facilitate the ability to identify the respective data associated with different sessions. Accordingly, there are generally no intermediary lead-out, linking sectors or lead-in portions to separate such different sessions. Indeed, the data of FIG. 7 need not be associated with a file system at all; for example, the data of FIG. 7 can represent audio data on a CD, etc.

FIG. 8 provides a related format 224 for a recordable or hybrid disc to which data are recorded over multiple recording sessions under a single file system. For purposes herein, the term “session” will be defined as a full set of operations carried out to successfully place content data on the associated medium that can be subsequently recovered by a readback system as in FIG. 1. The mastering and replication process described with respect to FIGS. 2 and 3 would be viewed as a single recording session, as would the operation of the system of FIG. 6 by a user to successfully record desired content data to a recordable disc using a personal computer.

It will be noted that in the latter example, if at the conclusion of the writing process the user immediately followed up by a relaunching of the attendant PC application program to begin afresh and add a new set of content data to the disc, such would be viewed as two separate sessions, even if such operations occurred sequentially in time. Thus, the term “session” as used herein is given its ordinary meaning as understood by those skilled in the art.

The format 224 in FIG. 8 has lead-in, program area and lead-out zones 226, 228 and 230, as before. A first track (TRACK 1) 232 comprises content data stored during a first recording session, and a second track (TRACK 2) 234 comprises content data that is subsequently added to the disc during a second recording session. Other fields shown in FIG. 8 include a pause field (P1) 236, a run-out field 238, a link field 240, and a run-in field 242 in the program area 228, and a TOC 244 in the lead-in 226. Of particular interest is the format of the link field 240, which will be discussed in detail below.

For at least certain types of recordable media such as CD-R and CD-R/W, the writer system (e.g., 180) may not rely upon the TOC 244 in recording mode. Instead, the system may utilize a recordable memory area (RMA) field 246. This field can be located in any suitable location, such as in the lead-in zone 226.

As those skilled in the art will recognize, the RMA 246 stores various information with regard to the content on the disc, such as the start and end locations for each recording session. For example, at the end of session 1 (i.e., the writing of TRACK 1), the RMA 246 stores one start/end location for session 1. At the end of session 2 (i.e., the writing of TRACK 2), the RMA 246 is updated to store a second start/end location for the second session, and so on. When the disc is full, or it is determined that no additional data will be written to the disc, the writer 180 can create a table of contents from the RMA 246 and writes this to the TOC field 244 in the lead-in zone 226. It will be noted that once the TOC 244 has been written, the recordable disc can be read by any standard readback system as if the disc were actually a pre-recorded, embossed disc, if the content is of a selected type (e.g., CD audio).

Of particular note are the run-out, link and run-in fields 238, 240 and 242 in FIG. 8. These fields are configured in accordance with various specifications (CD, DVD, BD etc.) to provide sufficient separation between the different sessions to enable recovery of the user data associated with such sessions. Of particular interest is the link field 240, which comprises a dead zone to which no data have been written, and serves to separate the respective sessions by a sufficient mechanical margin (e.g., 1 mm or more) to ensure proper detection of the end of one session and the beginning of a next session can be carried out by a reader system (such as in FIG. 1).

FIG. 9 shows a format 254 that is similar to that of FIG. 8, and so like reference numerals have been used for similar features in both drawings. The format 254 is suitable for certain types of ROM discs, such as CD-ROM, which can utilize one or more file systems.

As those skilled in the art will recognize, some optical discs (and other types of media) store data in the form of files, which can be defined as logical groupings of sectors, the respective contents of which are combined to form a larger data structure (e.g., a “file”). File system conventions will vary depending upon the operational environment, but generally each entry in the file system will logically identify the start and end address of each file on the disc (or portion thereof).

During the first recording session to the disc in FIG. 9, a first file system field 256 was incorporated into the TRACK 1 field 232 in order to identify the files stored in that track. During the subsequent recording session, a second file system field 258 was incorporated into the TRACK 2 field 234 to identify the file system information associated with the second track.

At this point it will be noted that the arrangement of FIG. 9 can be used to alternatively illustrate either a single file system or a multiple file system. In the case of a single file system, the second file system field 258 incorporates the data in the first file system field 256 and appends the data associated with the second session. In this way, upon access by a reader the second file system field 258 will be located and accessed first, and this file system field 258 will identify to the reader the requisite information necessary to access all of the files stored on the medium.

In the case of a multi-file system arrangement, the first file system is represented by the user data of the first session. The file system data for this system is stored in the first file system field 256. The second file system is represented by the user data in the second session, and the file system data for this second system is stored in the second file system field 258. In some embodiments, these file systems may be different such that certain types of reader devices can only access certain types of file systems. For example, the first file system in FIG. 8 may be arranged for access by a first reader system, such as a PC. The second file system in FIG. 8 may be arranged for access by a second reader system, such as a game system. The respective readers may or may not be aware of the existence of the other file systems on the medium, and these respective readers may or may not be able to access both file systems of the respective sessions.

While operable, there are a number of undesirable limitations associated with these and other multi-session recording schemes. The overhead in terms of unusable space to accommodate multiple recording sessions can become significant, and can adversely affect the ability to place a desired amount of content onto a single disc (or single layer). This is particularly true due to the requirements to provide linking fields such as 240 between the various sessions.

Under many current schemes, even the addition of a very small recording session, such as the addition of a drive serial number, can require a new track, as well as all of the attendant fields associated therewith such as a new file system, run-in and run-out fields, etc.

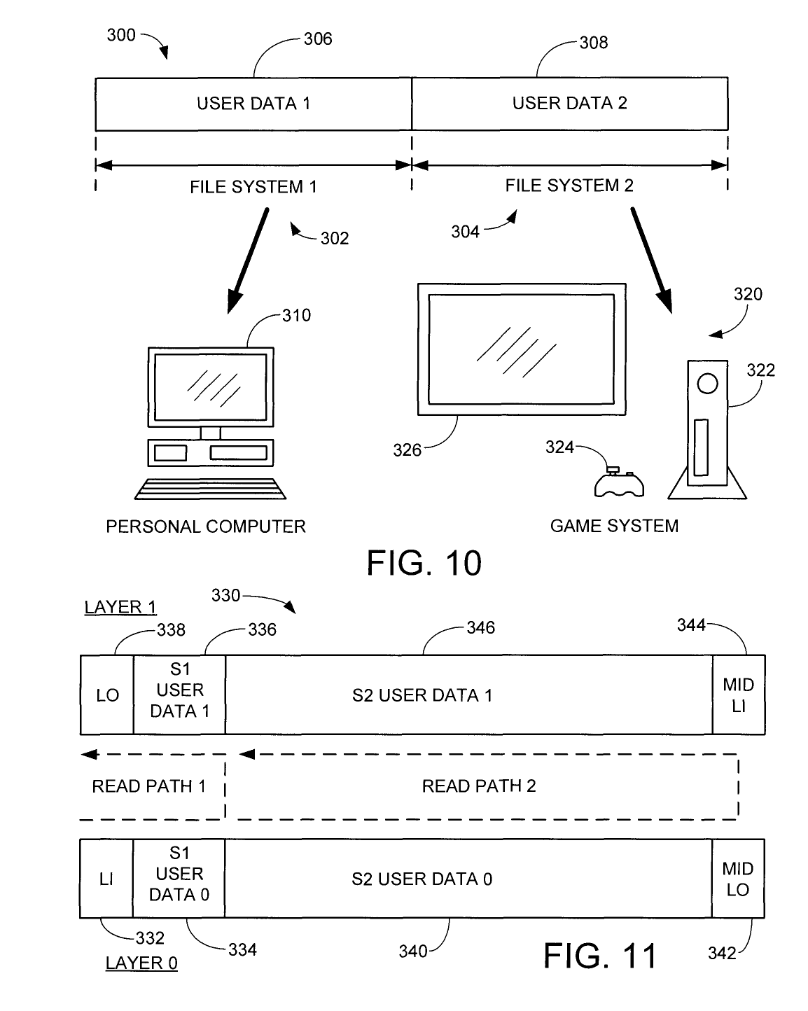

Accordingly, FIG. 10 provides a novel format 300 for an optical disc or other type of storage medium with an improved and efficient multi-session capability in accordance with various embodiments of the present invention. The format 300 represents an overall exemplary functional layout of the data on the medium, and may be arranged across one or more recording layers.

The exemplary format 300 includes data associated with a first file system 302 and a second file system 304. The first file system 302 generally constitutes a user data portion 308. The second file system 304 generally constitutes a user data portion 310. It will be noted that the various run-in, run-out and linking fields associated with these respective areas are eliminated from the medium. Other configurations are readily contemplated, so the arrangement of FIG. 10 is for purposes of illustration and is not limiting.

In some exemplary embodiments, the first file system 302 stores programming and features accessible by a personal computer 310, while the second file system 304 stores game programming and data accessible by a game system 320. For reference, the game system 320 is shown to incorporate a console 322 and controller 324 to provide a/v output with a television monitor 326, although other configurations are contemplated.

As generally represented in FIG. 10, it will be noted that no linking sectors are disposed between the respective sessions (that is, between the respective portions 302 and 304). This allows the space that would have otherwise been used in this area to be utilized by one or both of the respective file systems. In this way, the respective sessions are said to be in contacting abutment, and there are no intervening sectors between the respective sessions that are not utilized by either the first or second file systems.

The respective sessions in FIG. 10 can take any number of forms depending on the requirements of a given application. For example, with reference again to FIG. 9, each of the sessions can include a file system field, a lead-in field, a lead-out field, a user data field, etc. As noted above, however, unnecessary fields such as the RO, RI and L fields in FIG. 9 are eliminated between the respective sessions, freeing up additional space on the medium.

The various fields shown in FIG. 10 can be provided with attributes, expressed as one or multi-bit fields in the respective sectors that identify to the respective reader systems (e.g., 310, 320) which portion is being accessed. The use of such attributes can be specified for different types of readers, media, etc. In some embodiments, unique attributes are assigned to each of the different portions in FIG. 10, thereby allowing the respective portions to be identified when a seek is carried out and, if necessary, a correction in the placement of the associated reader (e.g., optical pickup) to the desired location on the medium. The attributes are utilized by the local servo control of the respective readers, and may not necessarily be passed to the host (e.g., by an optical disc drive ODD in the PC 310 or console 322, not the PC or console itself).

The skilled artisan will appreciate that a “hiccup” may occur in the modulation path as, for example, the first file system continues to read the data past the user data field 306 and into the user data field 308. However, in accordance with the characteristic operation of these respective types of readers, the known extent of the file system is set forth in the file system field (stored near the beginning of each of the fields 306, 308 and therefore omitted for clarity). In practice, it is contemplated that the respective readers will not attempt to continue reading data addresses not set forth in the respective file systems. Thus, as desired, the LBA numbering of the second user data field 308 can begin at any desired value, including at LBA 0 (so that there are two LBA 0 sectors on the medium). In other embodiments, however, other LBA range designations can be made, including respective ranges of LBAs that do not overlap.

FIG. 11 provides another representation of a format 330 generally similar to that of FIG. 10. FIG. 11 is contemplated as being arranged on a DVD-9 compatible optical disc with two layers (layers 0 and 1, respectively). A first read path (read path 1) shows a sequence of fields read by a first reader (such as the PC 310 in FIG. 10) during access to a first file system on the medium. This first read path is shown to include exemplary fields as follows: a layer 0 lead-in field 332 (LI-0); a session 1 user data 0 field 334 (S1 user data 0); a session 1 user data 1 field 336 (S1 user data 1); and a layer 1 lead-out field 338 (LO-1).

A second read path (read path 2) is provided for a second file system on the medium, and is read by a second reader (such as the game system 320, FIG. 10). This exemplary second read path includes: a session 2 user data field on layer 0, field 340 (S2 user data 0); a middle area for layer 0, field 342 (MID LO); a middle area for layer 1, field 344 (MID LI); and a session 2 user data field on layer 1, field 346 (S2 user data 1). As before, other arrangements are contemplated.

From FIG. 11 it will be appreciated that the respective file systems for the respective sessions can contactingly abut each other at any appropriate location, so that it is not necessarily required that the overall read path follow a traditional pass along the entirety of the first layer (layer 0) before transitioning to a second layer (layer 1). Moreover, it will be appreciated that each of the respective user data areas of FIGS. 10 and 11 can in turn incorporate the use of multiple sessions, and such sessions need not include the use of run-in, run-out and linking sectors as in the related art.

It is contemplated that the respective exemplary formats 300, 330 in FIGS. 10 and 11 are preferably organized as prerecorded discs (either embossed pits and lands or stripes as set forth in FIGS. 2, 4). It is further contemplated that all of the data on the respective formats will be recorded during a concurrent recording session (either a mastering or recording operation, as desired).

As will be appreciated by those skilled in the art, the historic use of linking sectors generally related to the fact that the root of multi-session recording was developed in recordable media, and for purposes of compatibility adopted the prior history of pre-recorded media. The designers of these formats wanted to ensure that the recordable discs, after recording, matched the pre-recorded specs. Thus, since pre-recorded discs were specified to provide certain buffer zones (the run-in, run-out and linking sectors), recordable discs did as well. This was believed to help ensure that the recordable discs would play just as reliably as pre-recorded discs in the respective readers. The duration of the linking areas up to the present day is simply a holdover from the pre-recorded specs to ensure compatibility between media and ODDs.

It can be seen that from a practical standpoint, the proposed exemplary formats 300, 330 will generally operate with existing systems without error. This is because the size of the gap between different sessions is filled with the control data information for the sessions. For example, for session 1 in FIGS. 10 and 11, the control data are located in the lead-in and instructs the associated ODD exactly where session 1 starts and ends on each layer (using PSN (Physical Sector Numbers). The control data for session 2 is stored at a different location and will instruct the ODD exactly where session 2 starts and ends on each layer, again using PSNs. As an aside, every sector in the layer is sequentially numbered using PSN's, there are no gaps or jumps in these PSN's even between sessions.

Using Layer 0 as an example, if control data for session 1 indicates layer 0 ends at PSN 1000, and control data for session 2 indicates layer 0 starts at PSN 2000, then there are exactly 999 linking sectors on layer 0. If, however control data for session 1 indicates layer 0 ends at PSN 1000 and control data for session 2 indicates layer 0 starts at PSN 1001, there are 0 linking sectors on layer 0.

Once the ODD recovers the control data for the session to be read, it will use that control information to internally map LBA (Logical Block Address) from the PC to PSN (PC's access data by LBA, ODD's only use PSN). Once the mapping has been installed in the ODD, then the O/S will start reading LBA 0 and recover the file system data. This is why both sessions will both start with LBA 0, and why a computer cannot see data from both sessions at one time, the LBA commands it will issue to the ODD will only correspond to one particular session (when the disc is pre-recorded multi-session with two different file systems, as embodied herein). It is not necessarily required, however, that the multiple sessions be described by different file systems, so that the LBAs of the second session can begin where the LBAs end off on the first session.

If the disc were a traditional multi-session with an extendable file system, there would not be any hidden control information for the second session. Instead, the OS/ODD would attempt to seek beyond the first session the prescribed number of sectors which the linking area take up. This may be why the number of linking sectors is written into the existing specifications. If an extension to the first file system is found, then those entries are appended to the first file system. If nothing is found, then there is no second session. This is why a computer can see all sessions in these type of multi-session discs when they contain an extendable file system.

Accordingly, the middle area (run-in, run-out, linking sectors) can be readily removed between sessions in a multi-session, multiple file system medium, allowing this available storage space to accommodate user data.

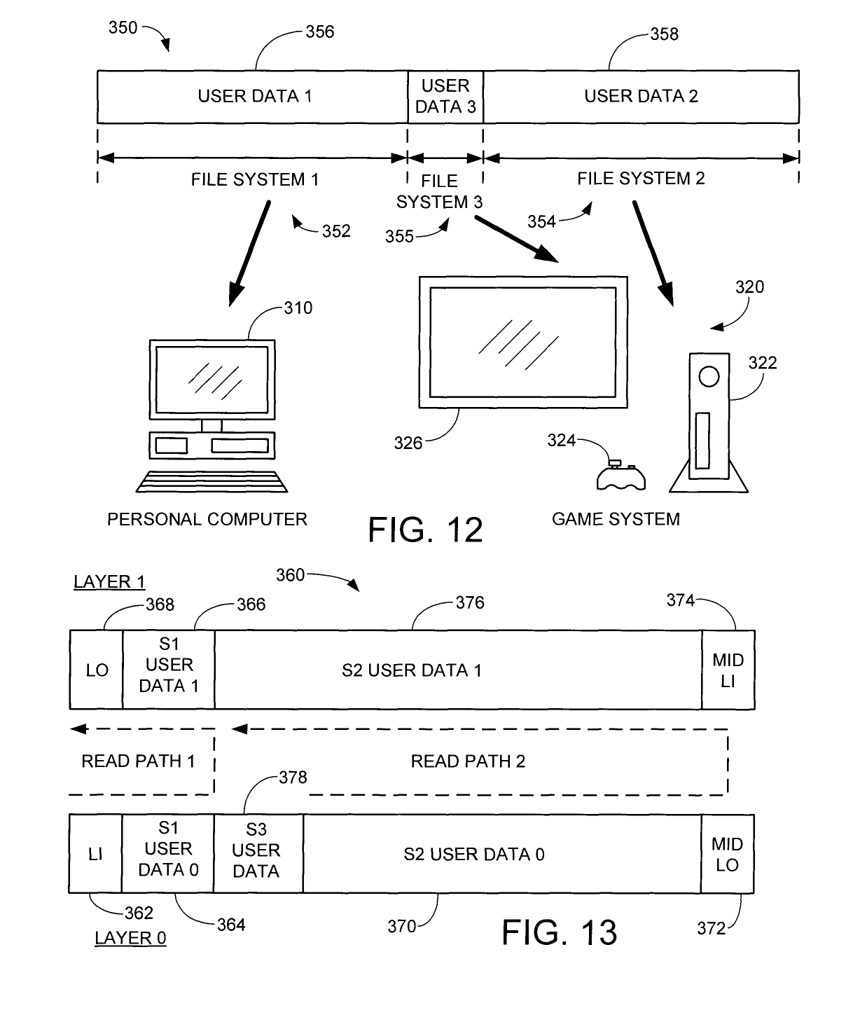

Alternative embodiments generally similar to those of FIGS. 10 and 11 are set forth in FIGS. 12 and 13. In FIG. 12, a format 350 is set forth with three file systems 352, 354 and 355 denoted as file systems 1-3. These are provided with associated user data portions 356, 358 and 359, denoted as user data 1-3. As before, no linking sectors are provided between the respective portions.

In FIG. 12, it is contemplated that the first file system 352 is accessed by the PC 310, the second file system 354 is accessed by the game system 320, and the third file system 355 is accessed by a different component, such as at the ODD level in the game module 322. Other alternatives are readily contemplated, however, so this is merely illustrative and not limiting.

FIG. 13 provides a related format 360 generally similar to the format 330 in FIG. 11 discussed above. As before, two separate read paths are shown for the first and second sessions stored thereon. For reference, the first read path is contemplated as including a first layer (layer 0) lead in portion 362, an S1 user data 0 portion 364, an S1 user data 1 portion 366, and a second layer (layer 1) lead out portion 368. The second read path is contemplated as including an S2 user data portion 370, a middle lead out portion 372, a middle lead in portion 374, and an S2 user data portion 376. A third read path (not specifically shown) involves accesses to an S3 user data portion 378 between the respective first and second paths.

The three paths are generally arranged as separate sessions, and as discussed above, are in contacting abutment on the disc in that they do not provide linking sectors therebetween. As before, each of these read paths can in turn involve multiple sessions, as required, again without the use of linking sectors therebetween.

In some embodiments, the third data of the portions 359, 378 in FIGS. 12-13 can comprise control data utilized by the associated system during accesses of the medium. Thus, while the third data are shown to be disposed between the respective first and second file systems, other locations can readily be utilized, such as being embedded in one of the other systems. For example, some or all of such third data can be located in one or both of the middle portions 372, 374.

It will be appreciated that the various embodiments presented herein can achieve benefits over formats of the prior art. The space savings provided by the abutment of the respective sessions eliminates the need and wasted space of the intermediary linking areas (linking sectors, etc.). Greater amounts of user data content can be accommodated on a given data storage format without regard to the number of sessions applied to place the content on the medium. The format can be applied to pre-recorded, recordable or hybrid formats as desired.

While the various embodiments presented herein have been directed to optical media such as CDs, DVDs and BDs, such is not necessarily limiting. Rather, the subject matter as claimed below can be applied to any number and types of storage media, including other forms of rotatable media and solid state memory (e.g., Flash).

What is claimed is:

1. A method comprising:
recording a first session onto a data storage medium with a first set of user data; and
subsequently recording a second session onto the data storage medium with a second set of user data, the second session contactingly abutting the first session without the use of an intervening linking area therebetween.

2. The method of claim 1, wherein the first session includes a first file system that describes the first set of user data, and the second session includes a second file system that describes the second set of user data, the second file system independent of the first file system

3. The method of claim 2, wherein a total number of sectors are physically located between sectors storing the first set of user data in the first session and sectors storing the second set of user data in the second session, and wherein all of said total number of sectors are described by either the first file system or the second file system.

4. The method of claim 1, wherein the storage medium is characterized as a multi-layer optical disc comprising first and second recording layers, wherein a first portion of the first session is recorded the first layer and a remaining portion of the first session is recorded on the second layer, and wherein a first portion of the second session is recorded on the first layer and a remaining portion of the second session is recorded on the second layer.

5. The method of claim 1, wherein the storage medium is characterized as an optical disc.

6. A method comprising:
providing a recordable storage medium;
recording first data to the medium as a first session, the first session arranged as a plurality of sequentially arranged sectors; and
subsequently recording second data to the medium as a second session, the second session arranged as a plurality of sequentially arranged sectors on the medium that immediately begin following a last sector of the first session so that there are no intervening linking sectors between the first and second sessions.

7. The method of claim 6, wherein the first session is described by a first file system that associates logical block addresses (LBAs) to physical block addresses (PBAs) for the sectors that store the first data, and the second session is described by a second file system that associates LBAs to PBAs for the sectors that store the second data.

8. The method of claim 7, wherein the first file system is stored in a first file system field within the first session, and the second file system is stored in a second file system field stored within the second session.

9. The method of claim 6, wherein the first session includes a first file system that describes the first set of user data, and the second session includes a second file system that describes the second set of user data, the second file system independent of the first file system.

10. The method of claim 9, wherein a total number of sectors are physically located between sectors storing the first set of user data in the first session and sectors storing the second set of user data in the second session, and wherein all of said total number of sectors are described by either the first file system or the second file system.

11. The method of claim 6, wherein the medium is characterized as a multi-layer optical disc comprising first and second recording layers, wherein a first portion of the first session is recorded the first layer and a remaining portion of the first session is recorded on the second layer, and wherein a first portion of the second session is recorded on the first layer and a remaining portion of the second session is recorded on the second layer.

12. The method of claim 6, wherein the first session is arranged to be accessed by a personal computer (PC), the second session is arranged to be accessed by a game system, and wherein the first and second sessions are further arranged so that at least a selected one of the PC or game system cannot access a remaining one of the first or second sessions.

13. An apparatus comprising a multi-session data storage medium to which a first session and a second session are recorded, the first session comprising first data and the second session comprising second data, wherein the first session is in contacting abutment with the second session so that no linking sectors are disposed therebetween.

14. The apparatus of claim 13, wherein the first session is arranged as a plurality of sequentially arranged sectors on the medium, and the second session is arranged as a plurality of sequentially arranged sectors on the medium that immediately begin following a last sector of the first session so that there are no intervening linking sectors between the first and second sessions.

15. The apparatus of claim 13, wherein the first session is described by a first file system that associates logical block addresses (LBAs) to physical block addresses (PBAs) for the sectors that store the first data, and the second session is described by a second file system that associates LBAs to PBAs for the sectors that store the second data.

16. The apparatus of claim 15, wherein the first file system is stored in a first file system field within the first session, and the second file system is stored in a second file system field stored within the second session.

17. The apparatus of claim 13, wherein the first session includes a first file system that describes the first set of user data, and the second session includes a second file system that describes the second set of user data, the second file system independent of the first file system.

18. The apparatus of claim 17, wherein a total number of sectors are physically located between sectors storing the first set of user data in the first session and sectors storing the second set of user data in the second session, and wherein all of said total number of sectors are described by either the first file system or the second file system.

19. The apparatus of claim 13, wherein the optical disc is characterized as a multi-layer optical disc comprising first and second recording layers, wherein a first portion of the first session is recorded the first layer and a remaining portion of the first session is recorded on the second layer, and wherein a first portion of the second session is recorded on the first layer and a remaining portion of the second session is recorded on the second layer.

20. The apparatus of claim 13, wherein the first session is arranged to be accessed by a personal computer (PC), the second session is arranged to be accessed by a game system, and wherein the first and second sessions are further arranged so that at least a selected one of the PC or game system cannot access a remaining one of the first or second sessions.
